(19) United States
(12) Patent Application Publication
(10) Pub. No.: US 2010/0149425 A1
(43) Pub. Date: Jun. 17, 2010

(54) IMAGE PROCESSING SYSTEM AND IMAGE PROCESSOR

(75) Inventors: Po-Wei Chao, Taipei County (TW); Chung-Yen Lu, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/334,664

(22) Filed: Dec. 15, 2008

(51) Int. Cl. H04N 9/64

(52) U.S. Cl. 348/714

(57) ABSTRACT

An exemplary embodiment of an image processing system is provided, comprising an off-chip memory and an image processor. In the off-chip memory, a plurality of field buffers and frame buffers buffer intermediate data associated with an input image, and the image processor processes the input image and the intermediate data to generate an output image. The image processor processes three stages. In a pre-processing stage, the field buffers are read to perform a pre-process, and the pre-processing results are stored in the field buffers. In a de-interlacing stage, a plurality of first line buffers buffer the pre-processed results read from the field buffers, and a de-interlacing process is performed on the pre-processed results to generate a de-interlaced results. In a post-processing stage, a post-process is performed on the pre-processed results and the de-interlaced results to generate the output image.

### BACKGROUND OF THE INVENTION

1. Field of the Invention

The invention relates to image processing, and in particular, to an optimized image processor structure that reduces occupation of memory bandwidth.

2. Description of the Related Art

FIG. 1a shows a conventional image processing system 100, constructed by a chip and an off-chip memory 110. The chip implements an image processor 120 widely adaptable for various applications such as multimedia players, displays and televisions. An input image #IN may be a static image or a motion picture, transmitted in various signal formats such as National Television System Committee (NTSC) or Phase Alternating Line (PAL) standard compliant signals to the image processing system 100. Generally, the image processor 120 is able to implement sequentially enhancing various aspects of image quality in multiple stages. For example, a first pre-processor 122 may be provided to eliminate cross color interferences within the input image #IN. Cross color is referred to as interferences in chrominance information induced by luminance information. A second pre-processor 124 may be provided to perform noise reduction, and the noise reduction may comprise spatial noise reduction and temporal noise reduction, each using different memory resources. The input image #IN sent to the image processor 120 may be interlaced, which means even lines and odd lines of a frame, each referred to as a field of the frame, are separately and alternatively delivered. Therefore, a de-interlacing process is required to reorganize every two fields into a complete frame. In the image processor 120, a de-interlacer 130 is provided to perform the de-interlacing process based on pre-processed results I(t) output from the second pre-processor 124 to generate a de-interlaced frame P(t). One or more post-processes may be performed after the de-interlacing process, wherein the image data are processed frame by frame. For example, a post-processor 140 may perform motion judder cancellation or image resizing on the de-interlaced frame P(t) output from the de-interlacer 130. Furthermore, frame rate control may also be implemented in a stage (not shown) either prior or posterior to the de-interlacer 130.

To accomplish the aforementioned processes, the image processor 120 must rely on an off-chip memory 110, such as Dynamic Random Access Memory (DRAM) to buffer various intermediate data associated with the input image #IN. Thus, the efficient use of the memory bandwidth between the off-chip memory 110 and image processor 120 is critical to increase performance. For brevity of description, the input image #IN can be denoted as a sequential input field data S(t) where t is a time index. A plurality of field buffers 102 are allocated in the off-chip memory 110 to support the first pre-processor 122, cascaded as a delay line to buffer the field data S(t). The first pre-processor 122 may need one current field data S(t) and two previous field data S(t-1) and S(t-2) to perform a cross color suppression. Thus, at least two I/O transmissions between the field buffers 102 and the first pre-processor 122 are required. Likewise, the second pre-processor 124 requires one previous field data I(t-2) to perform noise reduction on a current field data I′(t). Thus, at least two field buffers 104 are required to buffer a current field data I(t) output from the second pre-processor 124. Meanwhile, the field data I(t) is also sent to a de-interlacer 130 for de-interlacing. The de-interlacer 130 requires two further field buffers 104 to provide previous field data I(t-1) and I(t-2) in order to perform the de-interlacing process to thereby generate a de-interlaced frame P(t). Consequently, a second pre-processor 124 and de-interlacer 130 may jointly require at least four I/O transmissions to access the field buffers 104, in which partial field data such as I(t-2) is redundantly transmitted. The de-interlaced frame P(t) is output to the post-processor 140 such that a post-process can be performed on the current frame P(t) to generate an output image #OUT. The post-process is performed frame by frame, and is not limited to motion judder cancellation (MJC) or image resizing (scaler).

FIG. 1b shows an exemplary de-interlacer 130 and a post-processor 140 of FIG. 1a. As described, the field data are half frames composed of a plurality of lines (columns), and the transmission of the field data may be performed line by line. The de-interlacer 130 can be divided into two parts, a plurality of line buffers 108 and a de-interlacer core 134. The line buffers 108 buffer the lines in each input field data I(t), I(t-1) and I(t-2). For example, the field data I(t-1) is buffered by two sequentially cascaded line buffers 108, such that the de-interlacer core 134 can simultaneously receive a current line D0 and two previous lines D1 and D2 required by a de-interlacing process. Since there are three field data I(t), I(t-1) and I(t-2) simultaneously sent to the de-interlacer 130, six line buffers 108 are respectively deployed as shown in FIG. 1b. The post-processor 140 shows a similar structure, in which the current de-interlaced frame P(t) sent from the de-interlacer 130 is buffered by five line buffers 108, and six lines E0, E1, E2, E3, E4 and E5 corresponding to the de-interlaced frame P(t) can be simultaneously sent to a post-processor core 144. However, the usage of the plurality of line buffers 108 increases production cost and chip size.

### BRIEF SUMMARY OF THE INVENTION

An exemplary embodiment of an image processing system is provided, comprising an off-chip memory and an image processor. The off-chip memory comprises a plurality of field buffers and frame buffers for buffering intermediate data associated with an input image, and the image processor processes the input image and the intermediate data to generate an output image.

The image processor processes three stages, a pre-processing stage, a de-interlacing stage and a post-processing stage. In the pre-processing stage, the field buffers are read to perform a pre-process, and the pre-processing results are stored in the field buffers. In the de-interlacing stage, a plurality of first line buffers buffer the pre-processed results read from the field buffers, and a de-interlacing process is performed on the pre-processed results to generate de-interlaced results. In the post-processing stage, a post-process is performed on the pre-processed results and the de-interlaced results to generate the output image.

Another embodiment provides an image processor, coupled to an off-chip memory. The image processor comprises a first frame rate controller, receiving the input image and a plurality of buffered field data from a plurality of first field buffers at a first rate, selecting a first number of field data therefrom, and outputting the first number of field data at a second rate. A first pre-processor then performs a pre-process on the first number of field data output from the first frame rate controller to generate an intermediate result. A second pre-processor performs noise reduction on the intermediate result to generate a noise reduction result. A de-interlacer de-interlaces the noise reduction result to generate a de-interlaced result. A first post-processor performs a post-process on the de-interlaced result to generate the output image.

A further embodiment of an image processor is provided, in which, a pre-processor sequentially outputs processed field data to a plurality of field buffers in the off-chip memory at a second rate, and performs noise reduction on the input image based on a previous field data buffered in a particular field buffer. A frame rate controller selects a first number of field data from an output of the pre-processor, and field data buffered in the plurality of field buffers, and outputs the first number of field data at a first rate. Thereafter, a de-interlacer performs a de-interlacing process on the first number of field data to generate a de-interlaced result.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1a shows a conventional image processing system;

FIG. 1b shows a de-interlacer 130 and a post-processor 140 according to FIG. 1a;

FIG. 2 shows an embodiment of an image processing system 200;

FIG. 3 shows an embodiment of a de-interlacer 310 and a first post-processor 320 according to FIG. 2; and

FIGS. 4a and 4b show embodiments of frame rate control.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides an enhanced image processor structure, in which partial data are shared within different stages to reduce memory bandwidth consumption. Specifically, line buffers within a stage may also be shared with another stage, and thereby the usage of field buffers or frame buffers can be reduced. Additionally, a control method is implemented on the field buffers 102 and field buffers 104 to provide an efficient frame rate control mechanism.

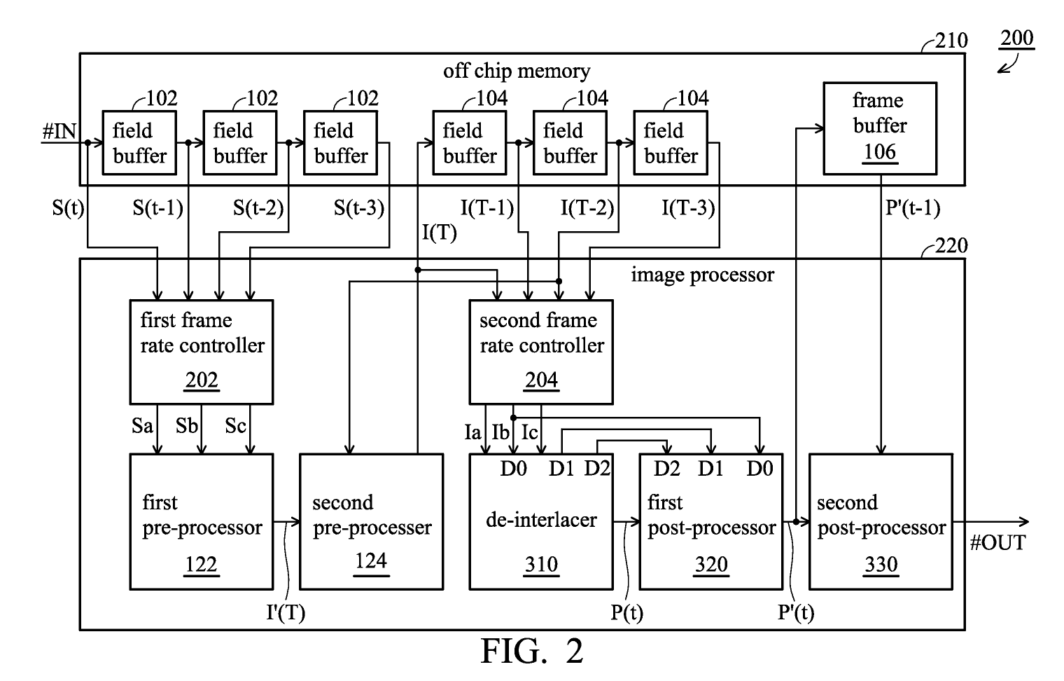

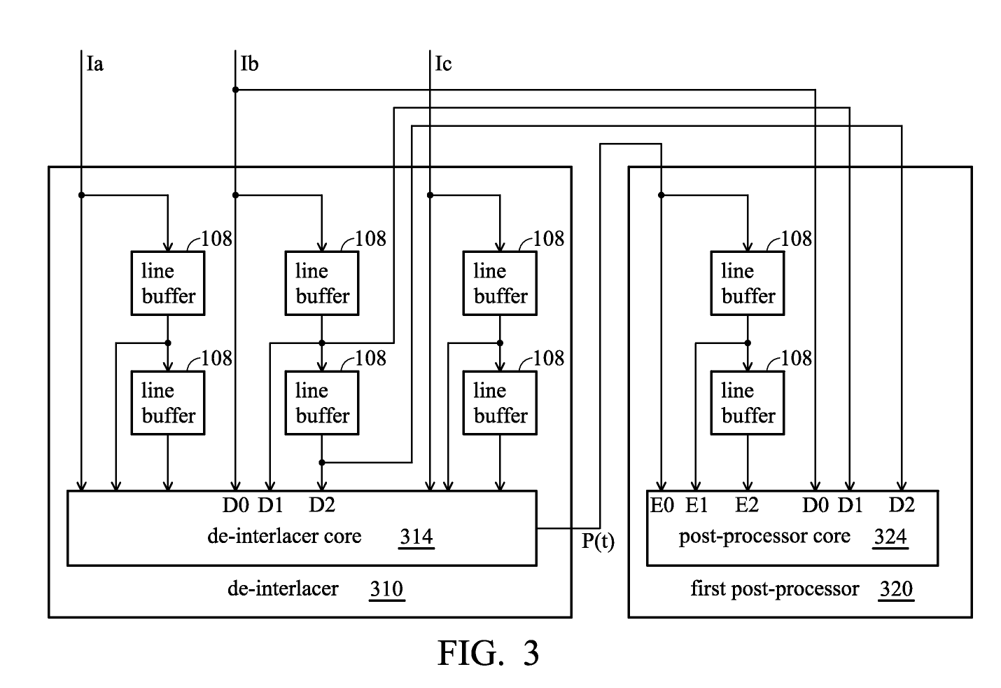

FIG. 2 shows an embodiment of an image processing system 200, comprising an off-chip memory 210 and an image processor 220. The image processor 220 is a multi-stage structure that receives an input image #IN to generate an output image #OUT. A plurality of field buffers and frame buffers are allocated in the off-chip memory 210 for buffering intermediate data associated with the input image #IN, so that the processes in each stage of the image processor 220 can be facilitated. In the embodiment, the image processor 220 can be categorized into three stages, a pre-process stage, a de-interlacing stage and a post-process stage. The pre-process stage comprises one or more processes before de-interlacing, wherein a plurality of previous field data S(t-1), S(t-2) and S(t-3) are read from field buffers 102 to be processed, and a pre-processed result I(T) is sent to the field buffers 104 for use by a next stage, or the de-interlacing stage. In the de-interlacing stage, a plurality of line buffers 108 (as shown in FIG. 3) are provided to buffer line data of the pre-processed results I(T) read from the field buffers 104, thereby performing a de-interlacing process to generate a de-interlaced frame P(t). The de-interlaced frame P(t) is then sent to a post-processing stage following the de-interlacing stage, wherein one or more post-processes are performed on the de-interlaced frame P(t) to generate the output image #OUT. In the embodiment, part of the pre-processed results I(T) stored in the field buffers 104 are passed to the post-process stage to help the post-processes, so that the usage of the off-chip memory 210 can be reduced. Detailed embodiments are described below.

As shown in FIG. 2, a first pre-processor 122 is used for various pre-processes that may be performed before de-interlacing, which may require two or three previous field data in addition to current field data per time index. The off-chip memory 210 comprises a plurality of field buffers 102 cascaded as a delay line to sequentially buffer the input image #IN. As a current field data S(t) is input, previous field data S(t-1), S(t-2) and S(t-3) are respectively generated from the field buffers 102. Generally, the previous field data S(t-1), S(t-2) along with the current field data S(t) may be directly sent to the first pre-processor 122. However, in some case, the frame rate of the input image #IN may be different from that of the output field data I′(T). For example, the input image #IN may be input to the field buffers 102 at a first rate, and if so, the first pre-processor 122 would output the I′(t) at a second rate higher or lower than the first rate. Therefore, a first frame rate controller 202 is provided to control the flow rate by selecting three outputs Sa, Sb and Sc out of four inputs S(t), S(t-1), S(t-2) and S(t-3), and the three selected outputs Sa, Sb and Sc are output at a second rate.

The first frame rate controller 202 is an optional unit required only when frame rate control is required. The frame rate control can be an up conversion or a down conversion. For example, the first rate may be 50 Hz while the second rate is 60 Hz, or oppositely, the first rate may be 60 Hz while the second rate is 50 Hz. The number of input ports and output ports of the first frame rate controller 202 can be flexibly designed. For example, the delay line of field buffers 102 may comprise more than three field buffers 102. If the first pre-processor 122 requires three field data at the same time, the number of the field buffers 102 must be no less than three, which allows the first frame rate controller 202 to select three field data out of four or more candidates. In the embodiment, the first pre-processor 122 can be a cross color suppressor, and consequently, the pre-process is a cross color suppression process.

Alternatively, the first pre-processor 122 may also be another pre-processor such as a noise reduction unit or an image sharpener. In the embodiment, the pre-process stage may optionally and preferably comprise a second pre-processor 124 following the first pre-processor 122 to perform the pre-processes not performed by the first pre-processor 122. The second pre-processor 124 requires a plurality of field buffers 104 to work, while a de-interlacer 310 in the de-interlacing stage may require the same field data from the field buffers 104. Thus, a plurality of field buffers 104 are allocated in the off-chip memory 210, simultaneously shared by the second pre-processor 124 and the de-interlacing stage. Like the field buffers 102, the field buffers 104 are cascaded as a delay line, dedicated to sequentially buffer pre-processed results I′(T) output from the second pre-processor 124.

In the embodiment, the second pre-processor 124 is a noise reduction unit for performing spatial noise reduction or temporal noise reduction on each field data. As described, the input image #IN are interlaced. Thus, the field data in two consecutive field buffers 104 are associated with different parts of a frame. For example, field buffers of even time indices may be correlated to the top field of a frame, and those of odd time indices may be correlated to even field of the frame. Regarding the case in the second frame rate controller 204, wherein the field buffers 104 sequentially output previous field data I(T-1), I(T-2) and I(T-3) while a current field data I(T) is generated and buffered thereto, the second pre-processor 124 requires a previous field data I(T-2) to perform the noise reduction, and the previous field data I(T-2) is available in a particular field buffer 104 associated with the same part of a frame as the input field data I′(T). Thus, the output of the particular field buffer 104 is connected to the second pre-processor.

In the de-interlacing stage, a de-interlacer 310 performs the de-interlacing process. Generally, three consecutive field data are required for a de-interlacing process. Thus, the de-interlacer 310 may directly receives the current field data I(T) from the second pre-processor 124, and two previous field data I(T-1) and I(T-2) from the field buffers 104. However, in some cases, frame rate control is required. For example, the field data I(T) is provided at a second rate, and the de-interlacer 310 may output a de-interlaced frame P(t) at a first rate. Thus, a second frame rate controller 204 similar to a first frame rate controller 202 can be implemented between the field buffers 104 and the de-interlacer 310. The second frame rate controller 204 receives four inputs, I(T), I(T-1), I(T-2) and I(T-3) from the second pre-processor 124 and field buffers 104, and selects three of them as the three outputs Ia, Ib, Ic that are output at the first rate. To control frame rate, the input ends of the second frame rate controller 204 are designated to be more than its output ends, where the number of output ends is dependent on the number of field data required by the de-interlacer 310.

In FIG. 2, a first post-processor 320 and a second post-processor 330 jointly form the post-processing stage. The first post-processor 320 stands for a post-process using line buffers shared from the de-interlacer 310, whereby the off-chip memory 210 is not occupied. The second post-processor 330 stands for an optional ordinary post-processor that utilizes a frame buffer 106 to perform the post-process, whereby an output image #OUT is generated from previous stage results. The frame buffer 106 outputs a previous P′(t-1) while buffering a current P′(t) output from the first post-processor 320. The first post-processor 320 and second post-processor 330 can be a scaler, a motion judder canceller or any processing unit that handles image data frame by frame. Namely, the post-process is an image resizing process, a motion judder cancellation process or other function specific processes.

The de-interlacer 310 receives the field data Ia, Ib and Ic line by line, and the field data Ia, Ib and Ic are buffered in a plurality of line buffers 108 before processing. FIG. 3 shows an embodiment of a de-interlacer 310 and a first post-processor 320 to better illustrate the operations performed by the line buffers 108. In the de-interlacer 310, each of the input field data Ia, Ib and Ic are buffered by two line buffers 108, respectively. Regarding the field data Ib, a current line D0 is sent to the de-interlacer core 314 while two previous lines D1 and D2 are sent from corresponding line buffers 108. The lines in the field data Ia and Ic are similarly processed, whereby the de-interlacer core 314 performs the de-interlacing line by line to output a de-interlaced frame P(t).

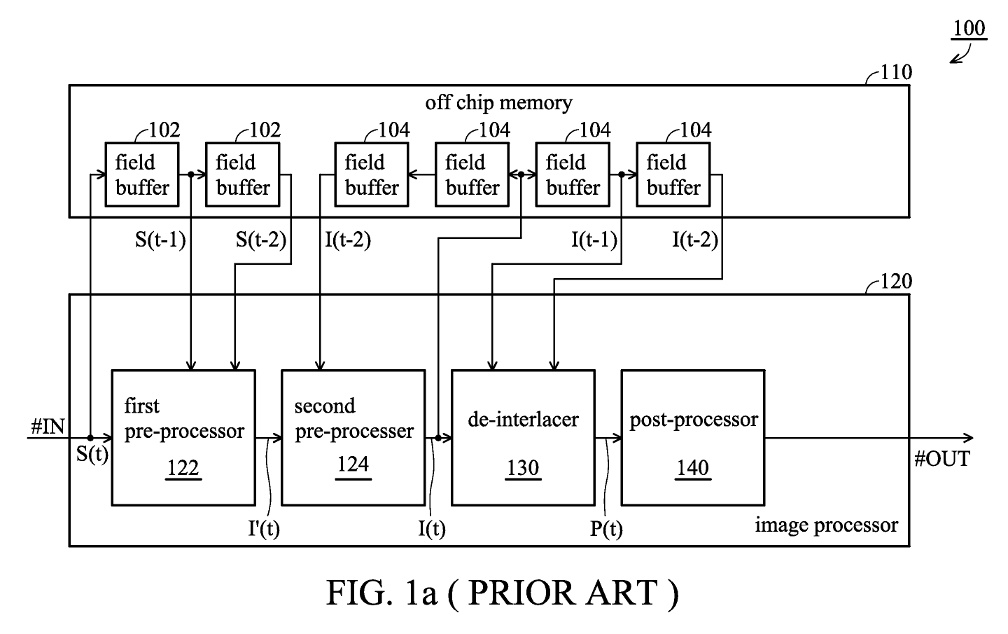

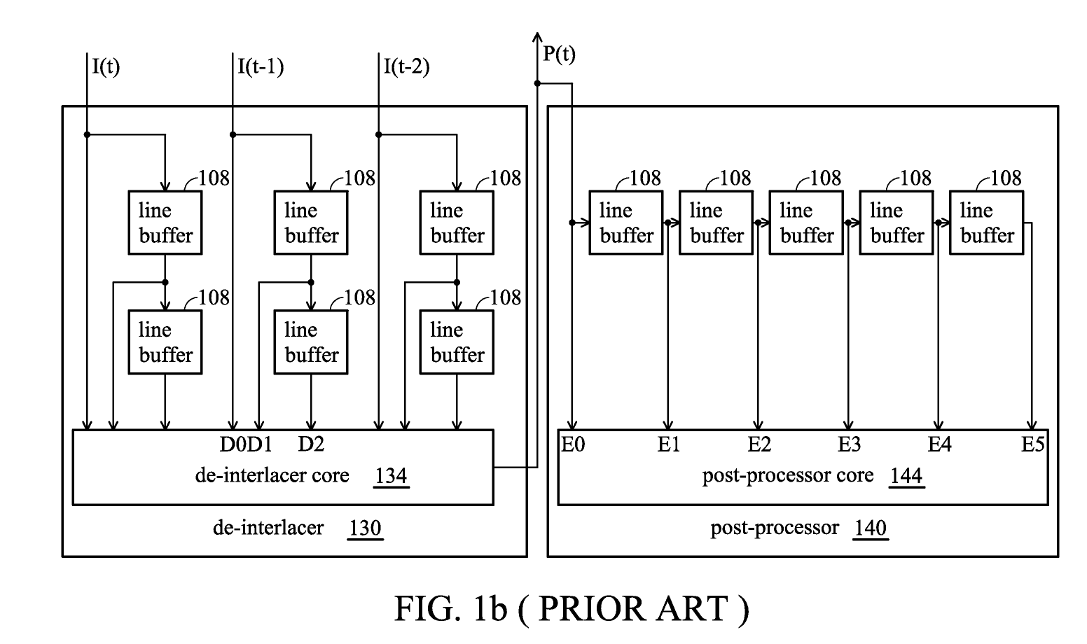

Regarding the first post-processor 320, likewise, field data are processed line by line. Two line buffers 108 are provided to buffer the de-interlaced frame P(t) output from the de-interlacer core 314. Thus, a current line E0 is sent to the post-processor core 324 while two previous lines E1 and E2 are sent from the corresponding line buffers 108. Meanwhile, the first post-processor 320 receives line data D0, D1 and D2 of the field data Ib from the corresponding line buffers 108 residing in the de-interlacer 310. This approach exhibits the same effects as when the line buffers 108 buffer the P(t-1) shown in the FIG. 1b. In other words, the embodiment reduces the number of line buffers 108 by sharing required data from the de-interlacer 310. Thus, the post-process is performed based on the field data Ib, the de-interlaced frame P(t), and their corresponding line buffers 108. It is noted that in some cases, only one line buffer 108 is required for the first post-processor 320. The number of line buffers required for the first post-processor 320 depends on the processing region thereof.

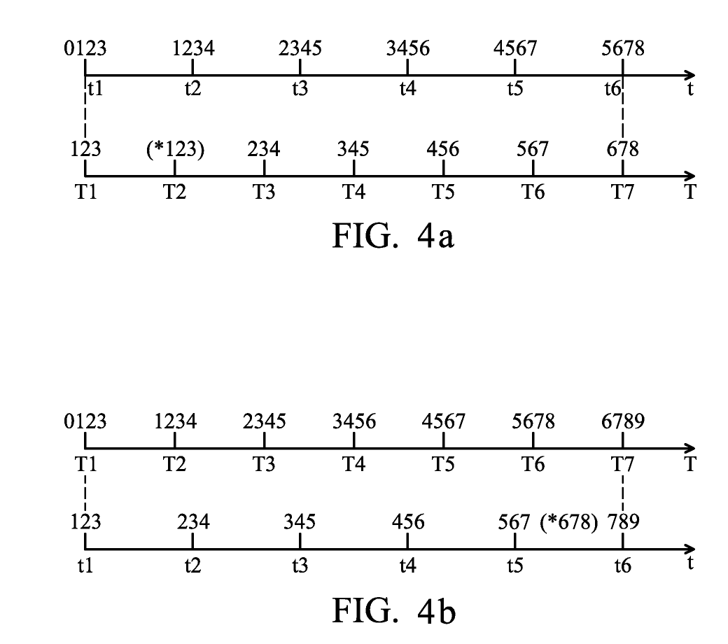

FIGS. 4a and 4b show embodiments of frame rate control. In FIG. 4a, a first time line t indicates data fields input at a lower frame rate, such as 50 Hz, and a second time line T indicates data fields output a higher frame rate, such as 60 Hz. The four digit numeric labels on the first time line t represent four input buffer statuses, and the three digit numeric labels on the second time line T represent three outputs selected by the frame rate controller. The buffer status is designated as 0123, which means three consecutive field data corresponding to the time index 1, 2 and 3 presently available in the field buffers (where 0 indicates an empty slot). Firstly, at time count T1, three field data 1, 2 and 3 are available, hence the frame rate controller selects the field data 1, 2 and 3 to be the output, designated as 123. Thereafter, when the time index goes to T2, the buffer status of the frame rate controller is not yet switched to 1234, thus, the last output 123 is repeatedly output again. As the time index goes to T3, the buffer status is 1234, thus, field data 2, 3 and 4 are selected to be the output, designated as 234. The procedure is repetitively proceeded, and as a result, with every fifty inputs, sixty outputs are output wherein ten of them are redundant.

FIG. 4b shows another frame rate controller different from the embodiment of FIG. 4a, where a first time line T indicates data fields input at a higher frame rate, such as 60 Hz, and a second time line t indicates data fields output at a lower frame rate, such as 50 Hz. Firstly, at time index t1 synchronous to T1, the buffer status is 0123, which means three field data 1, 2 and 3 are available, hence the frame rate controller selects the field data 1, 2 and 3 to be the output, designated as 123. Thereafter, when the time index goes to t2, the buffer status of the frame rate controller is 1234, thus, the frame rate controller selects field data 2, 3, and 4 as an output, designated as 234. Similarly, as the time index goes to t5, the buffer status is 4567, thus, field data 5, 6 and 7 are selected to be the output, designated as 567. When the time index goes to t6, the frame rate controller is supposed to output 678 which is successive to the previous output 567. However, since the first time line T has a higher update rate, the buffer status has advanced to 6789 while at the time index t6, thus, the frame rate controller does not select 678 to be the output, but 789 instead. In other words, the selection of 678 is skipped, designated as (*678) in FIG. 4b. The procedure is repetitively preceded, and as a result, with every sixty inputs, fifty outputs are output wherein ten of them are skipped.

In the embodiment, the pre-process and post-process stages are not limited to comprise one or more processing units. The first and second frame rate controllers 202 and 204 are optional, and can be separately included into or excluded from the embodiment. The frame rate control is not limited to be a down conversion or an up conversion. The number of field buffers 102 and 104 are dependent on requirements during practical implementations, and not necessarily like what is shown in FIG. 2. The invention provides a specific concept of buffer sharing whereby the memory bandwidth consumption between an image processor and the off-chip memory is effectively reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image processing system, comprising:
an off-chip memory, comprising a plurality of field buffers and frame buffers for buffering intermediate data associated with an input image; and
a image processor, coupled to the off-chip memory, processing the input image and the intermediate data to generate an output image, comprising:
a pre-processing stage, reading the field buffers to perform a pre-process, and storing pre-processed results in the field buffers;
a de-interlacing stage, comprising a plurality of first line buffers for buffering the pre-processed results read from the field buffers, performing a de-interlacing process on the pre-processed results to generate de-interlaced results; and
a post-processing stage, coupled to the de-interlacing stage, the field buffers and the first line buffers, performing a post-process on the pre-processed results and the de-interlaced results to generate the output image.

2. The image processing system as claimed in claim 1, wherein:
the off-chip memory comprises a plurality of first field buffers cascaded as a delay line to sequentially buffer the input image at a first rate; and
the pre-processing stage comprises:
a first frame rate controller coupled to the first field buffers, selecting a first number of field data from the input image and the first field buffers, and outputting the first number of field data at a second rate;
a first pre-processor coupled to the first frame rate controller, performing the pre-process on the first number of field data output from the first frame rate controller to generate an intermediate result.

3. The image processing system as claimed in claim 2, wherein the number of the first field buffers is designated to be no less than the first number.

4. The image processing system as claimed in claim 2, wherein the first pre-processor is a cross color suppressor, and the pre-process is a cross color suppression process.

5. The image processing system as claimed in claim 1, wherein:
the off-chip memory comprises a plurality of second field buffers cascaded as a delay line to sequentially buffer a plurality of pre-processed results at a second rate; and
the pre-processing stage comprises a second pre-processor coupled to a particular second field buffer, performing the pre-process based on a current field data and a previous field data buffered in the particular second field buffer to generate the pre-processed result.

6. The image processing system as claimed in claim 5, wherein the second pre-processor is a noise reduction unit for performing spatial noise reduction or temporal noise reduction on each field data.

7. The image processing system as claimed in claim 5, wherein the de-interlacing stage comprises:
a second frame rate controller, coupled to the second field buffers, selecting a second number of field data from the pre-processed results and the second field buffers and outputting the second number of field data at a first rate; and
a de-interlacer, coupled to the second frame rate controller, performing the de-interlacing process on the second number of field data to generate the de-interlaced results.

8. The image processing system as claimed in claim 7, wherein the number of the second field buffers is designated to be no less than the second number.

9. The image processing system as claimed in claim 5, wherein:
the first line buffers in the de-interlacer respectively buffer the second number of field data output from the second frame rate controller; and
the post processing stage comprises a first post-processor coupled to the second frame rate controller, the de-interlacer, and the first line buffers, performing the post-process based on a particular field data output from the second frame rate controller, one or more first line buffer data corresponding to the particular field data output from the second frame rate controller, and the de-interlaced results.

10. The image processing system as claimed in claim 9, wherein the first post-processor comprises a plurality of second line buffers to buffer the de-interlaced results, and the first post-processor further uses the de-interlaced results buffered in the second line buffers to perform the post-process.

11. The image processing system as claimed in claim 10, wherein the first post-processor is a scaler, and the post-process is an image resizing process.

12. The image processing system as claimed in claim 10, wherein the first post-processor is a motion judder canceller, and the post-process is a motion judder cancellation process.

13. The image processing system as claimed in claim 9, wherein:
the off-chip memory further comprises a frame buffer coupled to the first post-processor, for buffering a previous post-processed result generated from the first post-processor; and
the post-processing stage comprises a second post-processor, generating the output image based on the post-processed result and the previous post-processed result buffered in the frame buffer.

14. The image processing system as claimed in claim 13, wherein the second post-processor is a scaler and the second post-processor is a motion judder canceller.

15. An image processor, coupled to an off-chip memory comprising a plurality of field buffers and frame buffers buffering intermediate data associated with an input image, and processing the input image and the intermediate data to generate an output image, comprising:
a first frame rate controller, receiving the input image and a plurality of buffered field data from a plurality of first field buffers at a first rate, selecting a first number of field data therefrom and outputting the first number of field data at a second rate;
a first pre-processor, coupled to the first frame rate controller, performing a pre-process on the first number of field data output from the first frame rate controller to generate an intermediate result;
a second pre-processor, coupled to the first pre-processor, performing noise reduction on the intermediate result to generate a noise reduction result;
a de-interlacer, coupled to the second pre-processor, de-interlacing the noise reduction result to generate a de-interlaced results; and
a first post-processor, coupled to the de-interlacer, performing a post-process on the de-interlaced results to generate the output image.

16. The image processor as claimed in claim 15, wherein the number of the first field buffers is designated to be no less than the first number.

17. The image processor as claimed in claim 15, wherein:
the first pre-processor is a cross color suppressor, and the pre-process is a cross color suppression process; and
the first post-processor is a motion judder canceller or a scaler, and the post process is a motion judder cancellation process or an image resizing process, respectively.

18. An image processor, coupled to an off-chip memory comprising a plurality of field buffers and frame buffers buffering intermediate data associated with an input image, and processing the input image and the intermediate data to generate an output image, comprising:
a pre-processor, sequentially outputting processed field data to a plurality of field buffers in the off-chip memory at a second rate, and performing noise reduction on the input image based on a previous field data buffered in a particular field buffer;
a frame rate controller, coupled to the pre-processor, selecting a first number of field data from an output of the pre-processor and field data buffered in the plurality of field buffers, and outputting the first number of field data at a first rate; and
a de-interlacer, coupled to the frame rate controller, performing a de-interlacing process on the first number of field data to generate a de-interlaced results.

19. The image processor as claimed in claim 18, wherein the pre-processor performs spatial noise reduction or temporal noise reduction on each field data.

20. The image processor as claimed in claim 18, wherein the number of the field buffers is designated to be no less than the first number.

21. The image processor as claimed in claim 18, wherein:
the de-interlacer comprises a plurality of first line buffers, for respectively buffering the first number of field data output from the frame rate controller; and
the image processor further comprises a first post-processor coupled to the frame rate controller, the de-interlacer and the first line buffers, performing a post-process based on a particular field data output from the frame rate controller, one or more first line buffer data corresponding to the particular field data output from the frame rate controller, and the de-interlaced results.

22. The image processor as claimed in claim 21, wherein the first post-processor comprises a plurality of second line buffers to buffer the de-interlaced results, and the first post-processor further uses the de-interlaced results buffered in the second line buffers to perform the post-process.

23. The image processor as claimed in claim 21, wherein:
the first post-processor outputs a post-processed result to a frame buffer in the off-chip memory; and
the image processor further comprises a second post-processor, coupled to the output of the first post-processor, generating the output image based on the post-processed result and a previous post-processed result buffered in the frame buffer.
